(19) United States
(12) Patent Application Publication
(10) Pub. No.: US 2023/0022702 A1
(43) Pub. Date: Jan. 26, 2023

(54) A GRANULE OF POLYHALITE AND AMMONIUM SULPHATE AND A COMPACTION PROCESS FOR THE PRODUCTION THEREOF

(71) Applicant: ICL EUROPE COOPERATIEF U.A., Amsterdam (IL)

(72) Inventors: Khalil ABU-RABEAH, Beer Sheva (IL); Ruben SOCOLOVSKY, Beer Sheva (IL); Marina DAKOV, Arad (IL); Yacov LEVY, Dimona (IL); Natalia GEINIK, Arad (IL); Moshe GOLDFARB, Beer Sheva (IL)

(21) Appl. No.: 17/785,931

(22) PCT Filed: Dec. 28, 2020
(86) PCT No.: PCT/IL2020/051338

§ 371 Date: Jun. 16, 2022

Related U.S. Application Data
(60) Provisional application No. 62/966,097, filed on Jan. 27, 2020.

(51) Int. Cl. C05D 1/00; C05G 5/12; C05G 5/40

(52) U.S. Cl. CPC C05D 1/005; C05G 5/12; C05G 5/40

(57) ABSTRACT

According to some embodiments, there is provided herein a fertilizer granule comprising Polyhalite and Ammonium Sulphate, wherein said granule comprises a concentration of 40-60% w/w Polyhalite and 60-40% w/w of Ammonium Sulphate.

### FIELD OF THE INVENTION

The present invention relates to the field of fertilizers, specifically to production of compacted polyhalite and ammonium sulphate fertilizers.

### BACKGROUND OF THE INVENTION

To grow properly, plants need nutrients (nitrogen, potassium, calcium, zinc, magnesium, iron, manganese, etc.) which normally can be found in the soil. Sometimes fertilizers are needed to achieve a desired plant growth as these can enhance the growth of plants.

This growth of plants is met in two ways, the traditional one being additives that provide nutrients. The second mode by which some fertilizers act is to enhance the effectiveness of the soil by modifying its water retention and aeration. Fertilizers typically provide, in varying proportions, three main macronutrients:

Nitrogen (N): leaf growth;

Phosphorus (P): Development of roots, flowers, seeds, fruit;

Potassium (K): Strong stem growth, movement of water in plants, promotion of flowering and fruiting;

three secondary macronutrients: calcium (Ca), magnesium (Mg), and Sulphur (S); micronutrients: copper (Cu), iron (Fe), manganese (Mn), molybdenum (Mo), zinc (Zn), boron (B), and of occasional significance there are silicon (Si), cobalt (Co), and vanadium (V) plus rare mineral catalysts. The most reliable and effective way to make the availability of nutrients coincide with plant requirements is by controlling their release into the soil solution, using slow release or controlled release fertilizers.

Polyhalite is an evaporite mineral, a hydrated sulfate of potassium, calcium and magnesium with formula: K₂Ca2Mg(SO₄)₄2H₂O. Polyhalite is used as a fertilizer since it contains four important nutrients and is low in chloride:

48% SO₃ as sulfate

14% K₂O

6% MgO

17% CaO

Nitrogen is essential component for the plant. N containing fertilizers like Urea, ammonium nitrate, ammonium sulphate, calcium nitrate and Magnesium nitrate are useful for the plant's growth.

Ammonium sulphate; (NH₄)₂SO₄, is an inorganic salt containing 21% nitrogen and 24% sulfur.

Polyhalite and Ammonium sulphate, although both useful for the proper growth of a plant are practically un-mixable due to the fact that Ammonium Sulphate is considered a ductile material, and polyhalite is a mined non-ductile substance. Ammonium Sulphate has a low plasticity and therefore is difficult to compact so from a chemical point of view it is extremely difficult of cause the adherence of Polyhalite and Ammonium Sulphate.

### SUMMARY OF THE INVENTION

According to some embodiments, there is provided herein a fertilizer granule comprising Polyhalite and Ammonium Sulphate, wherein the granule may comprise a concentration of 40-60% w/w Polyhalite and 60-40% w/w of Ammonium Sulphate.

According to some embodiments, the granule may further comprise a binder, preferably, the binder may be vinasse.

According to some demonstrative embodiments there is provided herein a process for the compaction of Polyhalite with a Ammonium Sulphate comprising: mixing a feed of polyhalite with a feed of said Ammonium salts and binder in a mixer to yield a mixture; compacting in a compactor to yield masses; crushing said masses in a crusher to yield particles; and screening said particles in a screener to yield different particles in three different sizes: oversized particles which undergo a second crushing process and are retuned to said screener for screening, undersized particles which are transferred to said mixer for further mixing, and desired size granular particles which are transferred to a polish screener.

According to some embodiments, the final product may contain K₂O, SO₄, Mg and N.

### DETAILED DESCRIPTION OF THE INVENTION

According to some demonstrative embodiments, there is provided herein a fertilizer granule comprising Polyhalite and Ammonium Sulphate and optionally a binder.

According to some demonstrative embodiments, the granule may comprise a concentration of 40-60% w/w Polyhalite and 60-40% w/w of Ammonium Sulphate.

According to some demonstrative embodiments, there is provided herein a process for the compaction of Polyhalite with a Ammonium Sulphate. the process comprising: mixing a feed of polyhalite with a feed of said potassium salt and binder in a mixer to yield a mixture; compacting in a compactor to yield masses; crushing said masses in a crusher to yield particles; and screening said particles in a screener to yield different particles in three different sizes: oversized particles which undergo a second crushing process and are retuned to said screener for screening, undersized particles which are transferred to said mixer for further mixing, and desired size granular particles which are transferred to a polish screener.

The mixture for the compactor contains 40-60% polyhalite, 60-40% of Ammonium Sulphate and binder.

The mixing is performed in a blade blender and/or any other suitable devise capable of having a rotation speed that creates a swirling motion for a perfect homogenization and a high blending precision, e.g., a Ploughshare® Mixer.

The compaction may be a wet compaction.

The compaction process may include the addition of 1-5% binder.

The binder may include but not limited: for example, organic or inorganic binders, such as, starch, bentonite, sodium silicate, lignosulfonates, molasses, hydrated lime, bitumen, Portland cement, clay, cellulose gum, sucrose, water, water glass, cements, Fly Ash, Potassium and Sodium Silicate, MgO, CaO, Alganite, Molasses, Vinasses, Geo-polymers, oils and waxes and the like, or a combination thereof.

The dry compaction process may include the following steps:

Mixing Potash with Ammonium Sulphate according to the formula. Adding micronutrients.

Adding organic or inorganic binder between 1-5% preferably between 2-4%, 1-2% Adding water between 0.5-2%, preferably 0.5-1%.

The mixture may be heated to a temperature between 80-180° C., preferably 160° C.

Feeding the mixture into a compactor to provide compacted flakes;

Grinding of the flakes;

Sieving of the grinded flakes; and

After sieving there are three types of yield:
1. Desired sized flakes—between 14-33 mm thickness, S.G. between 1.9 to 2.4 g/cm³. According to some embodiments, the desired size of the flakes (also referred to herein as “particles” or “granules”) is between 1-6 mm, most preferably between 2-4 mm.
2. Oversized (OS) flakes—are returned to the grinding stage, e.g., between 4-20% w/w of the total resulting flakes.
3. Undersized (US) flakes—are recycled to the mixture for compaction, e.g., between 10 to 80% w/w of the total resulting flakes.

According to some embodiments, in the dry process, optionally a binder may be added in a concentration of between 0.01-7% w/w, preferably between 1-5% w/w, most preferably between 2-4% w/w.

The final product may submit to post-treatment. Oil may be added to the resulting granules, e.g., to improve the rheology of the product and diminish dust formation. Polishing the granules or Coating. The resulting flakes/granules may be glazed and further coated with a suitable coating.

For example, the coatings may include biodegradable coatings, sustained release coatings, controlled release coatings, oily coatings, wax coatings.

The dry compaction process may include the following steps:
1. Mixing materials—Polyhalite, ammonium in 200 lit mixer
2. Adding binder and mixing
3. Adding water and mixing
4. Compacting—Diameter 600 mm, width 145 mm. working force 90KN/cm. roll velocity 6 rpm.
5. Crushing using hammer mill
6. Screening
7. Drying the granule between 2-4 mm
8. Recycling-80%
9. Analysis. All analyses conducted according to the standard procedure

### Example 1

40% polyhalite+60% ammonium sulphate+0.8% water

Abrasion in—12 mesh 17%, 21% after 24 hours

Eco dust 1.6%, 1.3% after 24 hours

Strength of granule immediately after production 2.3 Kg granule

Strength of granule after 24 hours 2.0 Kg granule

Strength of granule after 1 month 3.2 Kg granule

### Example 2

38% polyhalite+60% ammonium sulphate+2% vinasse

Abrasion in—12 mesh 17%, 15% after 24 hours

Eco dust 1.1%, 1% after 24 hours

Strength of granule immediately after production 1.5 Kg granule

Strength of granule after 24 hours 1.6 Kg/granule

Strength of granule after 1 month 1.7 Kg granule

1. A fertilizer granule comprising Polyhalite and Ammonium Sulphate, wherein said granule comprises a concentration of 40-60% w/w Polyhalite and 60-40% w/w of Ammonium Sulphate.

2. The granule of claim 1, further comprising a binder.

3. The granule of claim 2, wherein said binder is vinasse.

4. A process for the compaction of Polyhalite with a Ammonium Sulphate comprising:
mixing a feed of polyhalite with a feed of said Ammonium salts and binder in a mixer to yield a mixture;
compacting in a compactor to yield masses;
crushing said masses in a crusher to yield particles; and
screening said particles in a screener to yield different particles in three different sizes: oversized particles which undergo a second crushing process and are retuned to said screener for screening, undersized particles which are transferred to said mixer for further mixing, and desired size granular particles which are transferred to a polish screener.
